(19) United States
(12) Patent Application Publication
(10) Pub. No.: US 2015/0085108 A1
(43) Pub. Date: Mar. 26, 2015

(54) LASERGRAMMETRY SYSTEM AND METHODS

(71) Applicant: Laser Projection Technologies, Londonderry, NH (US)

(72) Inventors: Steven P. Kaufman, Hooksett, NH (US); Arkady Savikovsky, Burlington, MA (US); Joel Stave, New Boston, NH (US)

(21) Appl. No.: 14/396,299

(22) PCT Filed: Mar. 22, 2013
(86) PCT No.: PCT/US2013/033550

§ 371 Date: Oct. 22, 2014

Related U.S. Application Data
(60) Provisional application No. 61/615,249, filed on Mar. 24, 2012.

(51) Int. Cl. G01B 11/24; G01B 11/00

(52) U.S. Cl. CPC G01B 11/24; G01B 11/005
USPC 348/135; 356/601

(57) ABSTRACT

A lasergrammetry system is disclosed, including: an aiming laser projector configured to direct a focused laser beam toward a designated point on a surface of an object thus producing a stationary laser light spot on the surface; and a sensing laser projector configured to scan, detect, and locate the laser light spot created by the aiming laser projector.

### CROSS REFERENCE TO RELATED APPLICATIONS

The present application claims the benefit of U.S. Provisional Patent Application No. 61/615,249, filed Mar. 24, 2012, the entire contents of which are incorporated herein by reference.

### FIELD OF DISCLOSURE

This invention relates to a system and methods for 3-dimensional measurement of the surface and/or features of an object.

### BACKGROUND

Many of today's advanced production processes require in-line quality control and in-process verification. This is especially important, for example, in aircraft manufacturing, where most of assembly operations are manual. Human errors are unacceptable and they have to be revealed immediately making sure they do not propagate into further production steps. One hundred percent quality assurance is often needed. Hence, in-process measurement of 3-dimensional structures, parts, and assemblies is frequently required. In a number of situations, especially involving composites, the only acceptable ways of 3D measurement are those employing non-contact methods, for example, lasergrammetry. Lasergrammetry is a non-contact measurement technology in which the 3D coordinates of points on an object are determined by utilizing laser pointing and scanning methods.

On the other hand, laser systems known as laser projectors are already widely used in contemporary manufacturing. Laser scanning technique in the form of laser projection is often utilized in production processes as a templating method in manufacturing of composite parts, in aircraft and marine industries or other large machinery assembly processes, truss building, painting, and other applications. It gives the user ability to eliminate expensive hard tools, jigs, templates, and fixtures. Laser projectors utilize computer-assisted design (CAD) data to generate glowing templates on a 3D object surface. Glowing templates generated by laser projection are used in production assembly processes to assist in the precise positioning of parts, components, and the like on any flat or curvilinear surfaces. Laser projection technology brings flexibility and full CAD compatibility into the assembly process. In the laser assisted assembly operation, a user positions component parts by aligning some features (edges, corners, etc.) of a part with the glowing template. After the part positioning is completed, the user fixes the part with respect to the article being assembled. However, the accuracy of laser projection, and, consequently, of the assembly process, is only adequate if the object is built exactly up to its CAD model. This is not the case for all applications, and as such there are a number of non-trivial issues associated with such applications.

### SUMMARY

In view of the above, the Applicants have realized that there are many applications where different manufacturing operations assisted by laser projection needed to be combined with in-process non-contact methods of 3D measurement including surface digitizing, feature detection, etc. Hence, there is a need for a combined laser projection and lasergrammetry system and methods.

In one aspect a lasergrammetry system, including: an aiming laser projector configured to direct a focused laser beam toward a designated point on a surface of an object thus producing a stationary laser light spot on the surface; and a sensing laser projector configured to scan, detect, and locate the laser light spot created by the aiming laser projector. In some embodiments, the aiming and sensing laser projectors are associated with aiming and sensing optical paths, respectively. Some embodiments include a computer configured to calculate 3D coordinates of the designated point using ray direction vectors associated with the aiming and sensing optical paths.

In some embodiments, a fixed set of fiducials are provided on the object, and both the aiming and the sensing laser projectors are further configured to obtain optical feedback signals from the fiducials and to define the location and orientation of the aiming and sensing projectors in 3D space with respect to a coordinate system of the object.

In some embodiments, the aiming laser projector includes a laser, a focusable beam expander, a beam steering system, a controller, and an optical feedback subsystem capable of detecting a portion of laser light reflected from a fiducial on the object.

In some embodiments, the optical feedback subsystem includes a photodetector configured to receive said portion of the reflected laser light and convert it into an electrical image signal that corresponds to the intensity of the detected feedback light.

In some embodiments, the sensing laser projector includes a laser, a focusable beam expander, a beam steering system, a controller, and an optical feedback subsystem capable of detecting a portion of laser light reflected from a fiducial on the object.

In some embodiments, the optical feedback subsystem includes a high sensitivity photodetector that is configured to detect said portion of the reflected laser light, and to detect a portion of the aiming projector's light reflected from the object surface.

In some embodiments, the optical feedback subsystem further includes an imaging lens having an optical axis and an aperture mask in front of the high sensitivity photodetector.

In some embodiments, the aperture mask is translatable together with the photodetector along the optical axis of the imaging lens.

In some embodiments, the sensing laser projector is configured to allow object feature detection.

In some embodiments, a set of fiducials are provided on the object, and the fiducials are inherent to the object.

In some embodiments, each of the aiming and sensing laser projectors is capable of functioning as the aiming laser projector or as the sensing laser projector.

In some embodiments, the system is configured for reverse engineering applications and to provide 3D coordinate measurements a group of points utilizing a bundle solution.

Some embodiments include a free located scale rod with at least two fiducials.

Some embodiments include at least one auxiliary video camera configured to image at least a portion of the object, where the system is configured to use a signal from the video camera to at least partially control the operation of the sensing projector.

In some embodiments, the video camera is configured to obtain one or more images of the laser light spot on the surface, and the system is configured to control the sensing projector to sense a limited area of the surface corresponding to the laser light spot based at least in part on the one or more images.

In another aspect, a lasergrammetry method is disclosed including: using an aiming laser projector to direct a focused laser beam toward a designated point on a surface of an object thus producing a stationary laser light spot on the surface; and using a sensing laser projector to scan, detect, and locate the laser light spot created by the aiming laser projector. In some embodiments, the aiming and sensing laser projectors are associated with aiming and sensing optical paths, respectively. Some embodiments include calculating 3D coordinates of the designated point using ray direction vectors associated with the aiming and sensing optical paths. In some embodiments, calculating step is carried out using at least one computer.

Some embodiments include providing a fixed set of fiducials on the object, and using the aiming and the sensing laser projectors to obtain optical feedback signals from the fiducials and to define the location and orientation of the aiming and sensing projectors in 3D space with respect to a coordinate system of the object.

In some embodiments, the aiming laser projector includes a laser, a focusable beam expander, a beam steering system, a controller, and an optical feedback subsystem. Some embodiments include using the optical feedback system to detect a portion of laser light reflected from a fiducial on the object.

In some embodiments, the optical feedback subsystem includes a photodetector. Some embodiments include using the photodetector to receive said portion of the reflected laser light and convert it into an electrical image signal that corresponds to the intensity of the detected feedback light.

In some embodiments, the sensing laser projector includes a laser, a focusable beam expander, a beam steering system, a controller, and an optical feedback subsystem. Some embodiments include using the optical feedback subsystem to detect a portion of laser light reflected from a fiducial on the object.

In some embodiments, the optical feedback subsystem includes a high sensitivity photodetector. Some embodiments include using the photodetector to detect said portion of the reflected laser light, and to detect a portion of the aiming projector's light reflected from the object surface.

In some embodiments, the optical feedback subsystem further includes an imaging lens having an optical axis and an aperture mask in front of the high sensitivity photodetector. Some embodiments include translating the aperture mask together with the photodetector along the optical axis of the imaging lens.

Some embodiments include detecting one or more features using the sensing laser projector.

In some embodiments, the object includes one or more inherent fiducials.

In some embodiments, each of the aiming and sensing laser projectors is capable of functioning as the aiming laser projector or as the sensing laser projector.

Some embodiments include implementing one or more reverse engineering applications; and providing 3D coordinate measurements a group of points utilizing a bundle solution.

Some embodiments include obtaining a video image of at least a portion of the object, and using a signal from the video camera to at least partially control the operation of the sensing projector.

Some embodiments include obtaining one or more images of the laser light spot on the surface, and controlling the sensing projector to sense a limited area of the surface corresponding to the laser light spot based at least in part on the one or more images.

In some embodiments, the object includes a set of fiducials, and the method includes: using the aiming projector and the fiducials to determine the location and orientation of the projector in 3D space with respect to the object's coordinate system based at least in part on coordinate data for the fiducials with respect to the coordinate system; using the sensing projector and the fiducials to determine the location and orientation of the projector in 3D space with respect to the object's coordinate system based at least in part on coordinate data for the fiducials with respect to the coordinate system; and performing a sequential point-by-point measurement of a surface of the object to obtains a series of digitized 3D coordinates of the surface. Some embodiments include comparing the series of digitized 3D coordinates of the surface to a model of the surface. Some embodiments include generating an output indicative of differences between the digitized 3D coordinates and the model.

In some embodiments, the object includes a set of fiducials, and the method includes: using the aiming projector and the fiducials to determine the location and orientation of the projector in 3D space with respect to the object's coordinate system based at least in part on coordinate data for the fiducials with respect to the coordinate system; using the sensing projector and the fiducials to determine the location and orientation of the projector in 3D space with respect to the object's coordinate system based at least in part on coordinate data for the fiducials with respect to the coordinate system; using the aiming and sensing projectors, to measure 3D coordinates of at least three points in the vicinity of a feature on the object having an edge; generating a model of the surface of the object in the vicinity of the feature based on the 3D coordinates; using the sensing projector to detect the edge of the feature; and determining 3D coordinates for one or more points associated with the edge. Some embodiments include determining beam steering angles associated with a plurality of points corresponding to the detected edge; determining a plurality of sensing rays based on the beam steering angles; and determining points where the sensing rays would intersect the surface based on the model of the surface. In some embodiments, the model includes a planar fit to the surface. In some embodiments, feature includes a hole. Some embodiments include performing process verification based on measurements of the object.

Some embodiments include providing a free located scale rod with at least two fiducials in the vicinity of the object. Some embodiments include scanning fiducials of the scale rod with the aiming projector and, the sensing projector; determining beam steering angles associated with the fiducials for both the aiming projector and the sensing projector; assigning object surface points for measurement, using the aiming laser projector, projecting stationary laser spots onto the surface of the object at desired points; using the sensing laser projector to scan the spots to determining the beam steering angles corresponding to the center of each spot for both the aiming projector and the sensing projector. In some embodiments, the step of using the sensing laser projector to scan the spots is performed while sensing projector is not projecting a laser beam. Some embodiments include performing a bundle solving calculation based on an entire set of beam steering angles for all the measurement points and the scale bar fiducials to generate 3D coordinates of all the measurement points.

In another aspect, a non-transitory computer readable media including a set of instructions that, when executed, case a lasergrammetry system to implement the method of any of the types descried above.

Various embodiments may include any of the above described elements, alone or in any suitable combination.

### BRIEF DESCRIPTION OF THE DRAWINGS

FIG. 1 is a diagram of a lasergrammetry system configured in accordance with an embodiment of the present invention.

FIG. 2 is a block diagram of an example aiming laser projector that can be used in the system of FIG. 1, in accordance with an embodiment of the present invention.

FIG. 3 is a perspective view of an example galvanometer based beam steering system that can be used in the aiming laser projector of FIG. 2, in accordance with an embodiment of the present invention.

FIG. 4 is a block diagram of an example sensing laser projector that can be used in the system of FIG. 1, in accordance with an embodiment of the present invention.

FIG. 5 is a diagram illustrating relation between components of the example optical feedback subsystem of the sensing laser projector of FIG. 4 and the object surface with the laser spot, in accordance with an embodiment of the present invention.

FIG. 6 is a detailed plan view of an example aperture mask that can be used in the sensing laser projector of FIG. 4, in accordance with an embodiment of the present invention.

FIG. 7 is a diagram of a lasergrammetry system configured in accordance with another embodiment of the present invention.

FIG. 8 is a diagram of a lasergrammetry system configured in accordance with yet another embodiment of the present invention.

FIG. 9 is an illustration with details related to a first example lasergrammetry method according to an embodiment of the present invention.

FIG. 10 is an illustration with details related to a second example lasergrammetry method according to another embodiment of the present invention.

FIG. 11 is a diagram of a lasergrammetry system configured with an auxiliary video camera in accordance with another embodiment of the present invention.

### DETAILED DESCRIPTION

Lasergrammetry techniques are disclosed. In one example embodiment, a lasergrammetry system is provided, the system including an aiming laser projector and a sensing laser projector. The aiming laser projector is configured to direct a focused laser beam toward a designated point on a surface of an object thus producing a stationary laser light spot on the surface. The sensing laser projector is configured to scan, detect, and locate the laser light spot created by the aiming laser projector. The aiming and sensing laser projectors are associated with aiming and sensing optical paths, respectively. The system may further include a computer configured to calculate 3D coordinates of the designated point using ray direction vectors associated with the aiming and sensing optical paths. The sensing and aiming laser projectors may be interchangeable allowing for dual functionality and/or configured to allow object feature detection. Numerous applications, methodologies, and system architectures will be apparent in light of this disclosure.

### General Overview

As previously explained, there are a number of non-trivial issues associated with laser assisted assembly operations, particularly given that the accuracy of laser projection, and, consequently, of the assembly process, is only adequate if the object is built exactly up to its CAD model, which is not always the case. For example, “as-build” thickness or shape of a large composite part may become different from “as-designed” during the lay-up process. In such situations, in-process 3D digitizing of the object surface can be used to facilitate accurate lay-up and assembly assisted by laser projection. Also, because the manual assembly process relies on the visual judgment of a worker, in-process verification is often required to double check an article placement. This is especially true for some industries with very strict production requirements like, for example, aircraft manufacturing. For such reasons, there are many applications where different manufacturing operations assisted by laser projection can be combined with in-process non-contact methods of 3D measurement including surface digitizing, feature detection, etc.

Thus, and in accordance with an embodiment of the present invention, a combined laser projection and lasergrammetry system is provided, along with various associated techniques. One specific example embodiment provides a lasergrammetry solution that is based on using at least two laser projectors. As will be appreciated in light of this disclosure, the main technique provided in accordance with such an embodiment can generally be referred to as probing an object surface with a laser spot. In accordance with one such embodiment, a first laser projector is designated for aiming and a second laser projector is designated for sensing. The “aiming” laser projector directs a focused laser beam toward a designated point on the object surface thus producing a stationary laser spot on the surface. The “sensing” laser projector scans, detects, and locates the laser light spot created by the “aiming” laser projector. The system can then calculate the 3D coordinates of the designated point using ray direction vectors associated with the aiming and sensing optical paths, in accordance with some such embodiments.

In one specific such embodiment, the lasergrammetry system for 3D measurement and in-process verification comprises the aiming and sensing laser projectors, a computer, and a fixed set of fiducials, for example, retro-reflective targets. The 3D coordinates of the fiducials are presumed to be known with respect to the object's coordinate system. Both the aiming and the sensing laser projectors have ability to obtain optical feedback signals from the fiducials and to define the location and orientation of the projectors in 3D space with respect to the object's coordinate system.

Continuing with the specific embodiment, the aiming projector includes a laser, a focusable beam a beam steering system, a controller, and an optical feedback subsystem capable of detecting a portion of the aiming projector's laser light reflected from a fiducial. The optical feedback subsystem of the aiming projector includes a photodetector that receives said portion of the reflected light and converts it into an electrical image signal that corresponds to the intensity of the detected feedback light. During the process of defining the aiming projector's location and orientation in 3D space with respect to the object's coordinate system (this defining is generally termed as “bucking-in”) this projector sequentially scans fiducials with its focused laser light spot. Fiducial scanning is performed by the projector's

In accordance with some such specific embodiments, the sensing projector also includes a laser, a focusable beam expander, a beam steering system, a controller, and an optical feedback subsystem. The sensing projector can define its location and orientation in 3D space with respect to the object's coordinate system, e.g. buck-in, in the same manner as previously described for the aiming projector. However, the optical feedback subsystem of the sensing projector includes a high sensitivity photodetector that is capable of detecting not only a portion of the sensing projector's own laser light reflected from a fiducial during bucking-in, but also capable of detecting a portion of the aiming projector's light reflected from the object surface area where the aiming projector directs its laser beam during the 3D measurement of an object surface point coordinates.

In accordance with some embodiments of the present invention, the optical feedback subsystem of the sensing laser projector includes an imaging lens and an aperture mask in front of the high sensitivity photodetector. The aperture mask is translatable together with the photodetector along the optical axis of the imaging lens. In the process of the object surface point measurement, the aiming projector uses its beam steering system to direct a focused laser beam toward the designated measurement point and the sensing projector uses its beam steering system to scan the area of the aimed laser light spot. The aperture mask serves as an image analyzer. The light passing through the aperture mask is captured by the high sensitivity photodetector. The last one converts the light into an electrical image signal. The signal is processed by the sensing projector's controller utilizing an image processing algorithm that computes a direction vector of the sensing optical path toward the center of the laser light spot. Consequently, the system's computer calculates the X, Y, Z coordinates of the measurement point utilizing the aiming ray direction vector data from the aiming projector and the sensing ray direction vector data from the sensing projector. Note that before the measurement scan, the aperture mask is placed into the image plane conjugate with the object surface area to be scanned. This technique substantially improves measurement precision by reducing the impact of laser light speckles, in accordance with some embodiments.

In another example embodiment, the sensing laser projector is enhanced to enable the object feature detection in accordance with the solution described in details in U.S. Pat. No. 7,306,339, the entire disclosure of which is incorporated herein by reference at Appendix A. In this becomes a part of the background and stray light suppressing system. Utilizing the sensing projector with object feature detection capabilities allows advanced types of 3D measurement and in-process verification, for example, to combine edge detection with surface or plane fitting through the designated measurement points.

In still another embodiment configured with two lasers, each of the laser projectors is capable of functioning as the aiming laser projector or as the sensing laser projector, and both can be enhanced to enable the object feature detection capabilities, in some such embodiments. This example embodiment offers a number of advantages. First of all, the system fiducials can be any type of features, such as holes, fasteners, dots, corners, or retro-reflective targets, for example. Second, as with the previous embodiment, such a system can perform advanced types of 3D measurement and in-process verification. Moreover, such a symmetrical system can achieve better accuracy by averaging the measurements performed, first, when one laser projector is aiming and the other is sensing and then, second, interchanging them so that the aiming projector becomes the sensing projector and the sensing projector becomes the aiming projector.

In another embodiment, a lasergrammetry system is provided that does not include a fixed set of fiducials with known coordinates. Instead, it includes just a free located scale rod with at least two fiducials. The distance between fiducials is presumed to be known. In accordance with this example embodiment of the present invention, such a system can be used for, instance, for general reverse engineering applications and it provides 3D coordinate measurements of a group of points utilizing a bundle solution method similar to conventional photogrammetry methods.

Numerous lasergrammetry methods for 3D coordinate measurements and in-process verification will be apparent in light of this disclosure.

For instance, a first example method is a lasergrammetry method for 3D digitizing of the surface of an object that relies on using at least two laser projectors—the aiming laser projector and the sensing laser projector. Some such embodiments can be based on utilizing a fixed set of fiducials. The 3D coordinates of the fiducials are presumed to be known with respect to the object's coordinate system. In accordance with one such specific example embodiment,
Bucking-in the aiming laser projector and the sensing laser projector into the object coordinate system using the given set of fiducials.
If the CAD model of the surface is known, selecting the desired surface point for measurement by its nominal coordinates, and then calculating the beam steering angles and projecting the stationary laser spot with the aiming projector onto the surface at the selected point. If the CAD model of the surface is not known, assigning the surface point for measurement by projecting the stationary laser spot with the aiming projector onto the unknown surface at a desired point.
Determining the aiming ray direction vector.
If the CAD model of the surface is known, calculating the beam steering angles for the sensing projector corresponding to the selected measurement point, then focusing the sensing projector aperture mask, and then scanning a predetermined small area that surrounds the aimed spot with the sensing projector while its own laser beam is turned off. If the CAD model of the surface is not known, producing a large search scan by the sensing projector first, detecting the location of the aimed spot, then calculating the beam steering angles for the sensing projector corresponding to the detected spot location, then focusing the sensing projector aperture mask, and then scanning a predetermined small area that surrounds the aimed spot with the sensing projector while its own laser beam is turned off
Processing the signal obtained from scanning of the predetermined small area that surrounds the aimed spot and determining the sensing ray direction vector corresponding to the center of the aimed spot.
Calculating 3D coordinates of the measurement point with respect to the object coordinate system using the obtained aiming and sensing rays.
Repeating the above steps for a plurality of measurement points to generate a series of digitized 3D coordinates of the surface. Note that the use of the term ‘steps’ as used herein is not intended to imply a rigid or otherwise fixed order, and other embodiments may have the various steps performed in different sequence.
If the CAD model of the surface is known, perform verification by comparing the measurement results with the model.

A second example method is a lasergrammetry method for advanced 3D measurement and in-process verification. This example embodiment combines 3D digitizing of the surface of an object with an edge detection technique and allows for measurement of a location of a given object edge in 3D space. Therefore, such embodiment provides a greater degree of flexibility and versatility relative to the first example. As will be appreciated, this method uses at least two laser projectors—the aiming laser projector and the sensing laser projector. At least one projector, which in some such embodiments is the sensing projector, is implemented with a laser projector configured with object feature detection capabilities. As will be further appreciated, such methodology can be based, for example, on utilizing a fixed set of fiducials. The 3D coordinates of the fiducials are presumed to be known with respect to the object's coordinate system. In accordance with one such specific example embodiment, the method includes the following:
Selecting or assigning a set of points on the object surface adjacent to the given edge that has to be measured.
Following the steps of the previous method (1) to buck-in both projectors and to measure assigned surface points in 3D space.
Running a surface fitting algorithm through the measured points.
Scanning the edge with the sensing projector while its own laser beam is turned on.
Processing the signal obtained from scanning and determining the sensing ray direction vectors associated with the edge points.
Determining the edge points in 3D space with respect to the object coordinate system by calculating the intersections between the sensing rays and the surface fit.

A third example method is a lasergrammetry method for general reverse engineering applications involving 3D surface digitizing. This example embodiment includes using at least two laser projectors—the aiming laser projector and the sensing laser projector. However, it does not require usage of a fixed fiducial set with known coordinates. Instead, it utilizes a free located scale rod with at least two fiducials. The distance between fiducials is presumed to be known. In accordance with one such specific example embodiment, the method includes the following:
Sequentially scanning fiducials of the scale rod, first with the aiming projector and, second, with the sensing projector.
Determining the beam steering angles associated with the fiducials for both the aiming projector and the sensing projector.
Sequentially assigning the object surface points for measurement, projecting the stationary laser spots by the aiming projector onto the unknown surface at desired points and scanning the spots by the sensing
projector with its own laser beam turned off and its aperture mask focused at every point.
Determining the beam steering angles corresponding to the center of each spot for both the aiming projector and the sensing projector.
Running a bundle solving calculation that simultaneously involves the whole set of beam steering angles for all the measurement points and the scale bar fiducials and results a set of X, Y, Z coordinates of all the
measurement points.

Thus, various example techniques can be used to provide, for example, a cost effective non-contact 3D measurement system that can be used for in-process verification combined with laser projection, in accordance with an embodiment of the present invention. The techniques have broad applicability and in some embodiments can be implemented as a highly sensitive and accurate in-process verification system that meets various challenging demands of today's production, for example, manufacturing of large composite parts for aerospace industry. In addition, the various lasergrammetry methods of non-contact 3D measurement and in-process verification are consistent with laser projection, in accordance with some embodiments. In addition, lasergrammetry systems and methods of non-contact 3D measurement are provided for various reverse engineering applications, in accordance with some embodiments of the present invention. Numerous other variations and configurations will be apparent in light of this disclosure.

### Lasergrammetry System Architecture

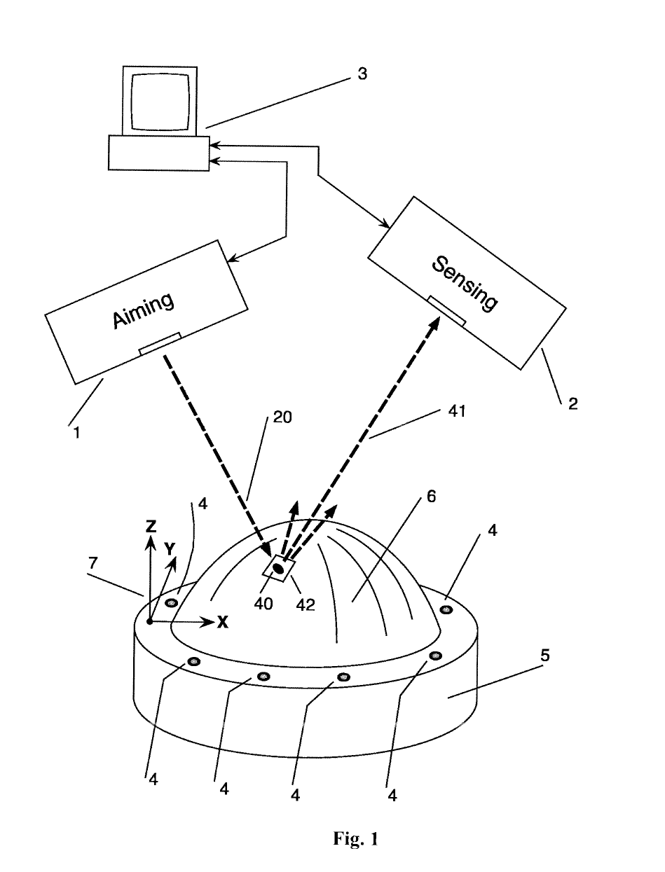

FIG. 1 shows an example lasergrammetry system configured in accordance with an embodiment of the present invention. As can be seen, the system includes an aiming laser projector 1, a sensing projector 2, a computer 3, and a plurality of fiducials 4 associated with an object 5. According to this embodiment, an example function of the lasergrammetry system is to measure 3D coordinates of chosen points on a surface 6 of the object 5. In this representative embodiment, the fiducials 4 can be, for instance, retro-reflective targets suitable for use in laser projection and photogrammetry applications. The fiducials 4 are located in such a way that their 3D coordinates are known with respect to a coordinate system 7 associated with the object 5.

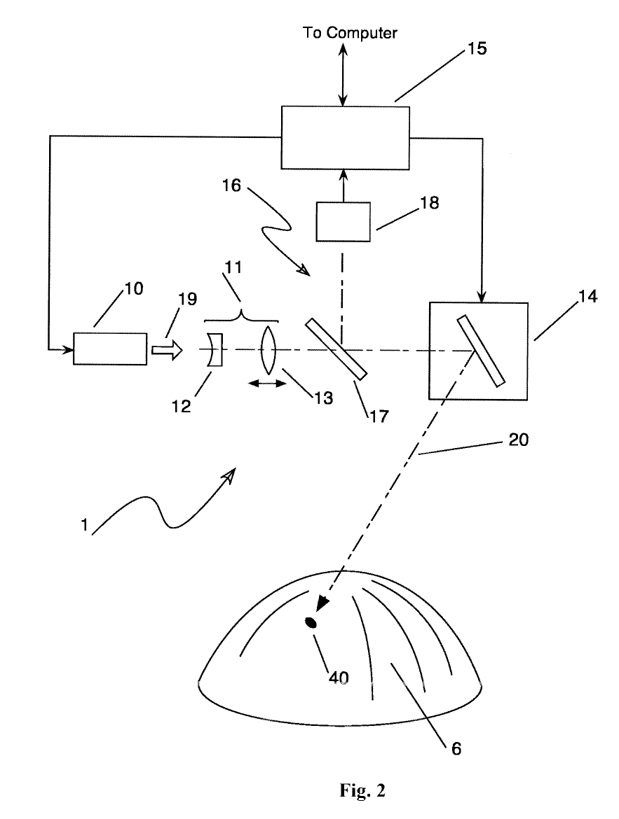

In some such embodiments, the aiming projector 1 can be implemented, for example, with a 3D industrial laser projector like the one disclosed in U.S. Pat. No. 6,547,397, the entire disclosure of which is incorporated herein by reference at Appendix A. An aiming projector 1 configured in accordance with one specific example embodiment is shown in FIG. 2. As can be seen, the aiming projector I includes a laser 10, a focusable beam expander II comprising a negative lens 12 and a positive lens 13, a beam steering system 14, a controller 15, and an optical feedback subsystem 16 comprising a pickup element 17 and a photodetector 18.

The laser 10 emits a laser beam 19. In some example embodiments, the laser 10 is implemented with a solid state diode pumped laser that produces light at the “green” wavelength of 532 nanometers, although other wavelengths can be used as will be appreciated. In some specific cases, the power of the beam 19 output by the laser 10 is not more than 5 milliwatts, which happens to correspond to the upper power limit for class IIIa lasers, and is a continuous wave output. Again, however, the specific laser parameters such as wavelength, power, beam shape and diameter, etc can vary from one embodiment to the next, and the claimed invention is not intended to be limited to any particular laser configuration. In operation, the laser 10 can be turned on and off by the controller 15 during scanning and projection operations of the laser projector 1. In some example cases, the laser beam 19 has a diameter of about 0.4 to 1.0 millimeters. In some embodiments, the beam expander 11 expands the laser beam about 10 to 15 times. The combination of lenses 12 and 13 also functions as a focusable beam collimator so that the laser projector output beam 20 can be focused on the surface 6 of the object 5. In some example embodiments, note that the positive lens 13 can be mounted on a slide (not shown) so it can be moved manually or automatically along its optical axis to re-focus the output beam 20 as the distance from the projector 1 to the surface 6 may vary.

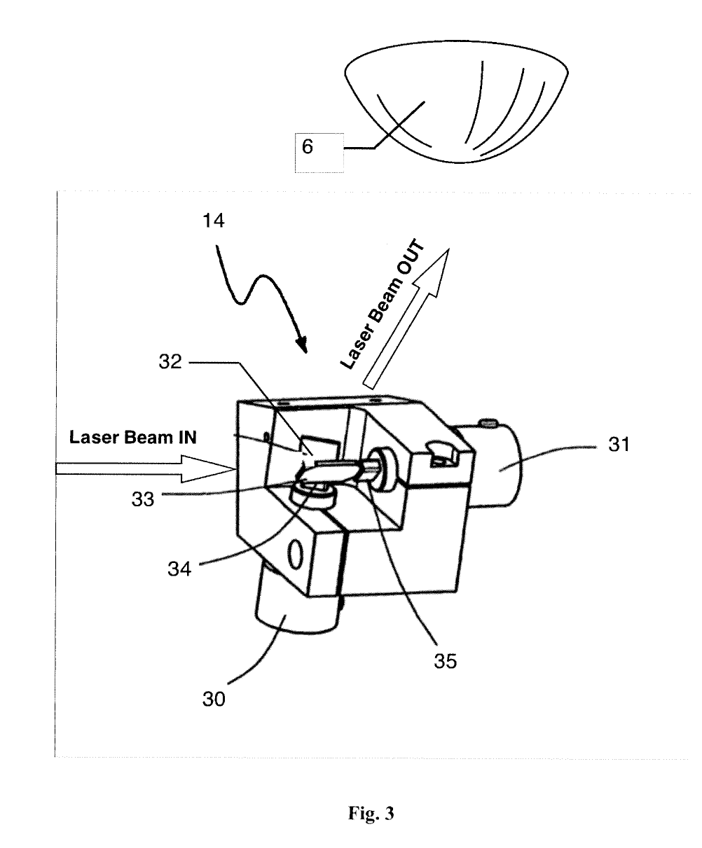

An example embodiment of the beam steering system 14 is shown in FIG. 3. As can be seen, this example beam steering system 14 is implemented as a two-axes galvanometer based system. It includes galvanometers 30 and 31. Beam steering mirrors 32 and 33 are mounted on the corresponding coupling clamps 34 and 35 attached to the shafts of galvanometers 30 and 31, respectively. The galvanometers are high precision servo motors containing angular position sensors. Example galvanometers that can be used in various applications for laser projection include, for example, models 6860 or 6220 made by Cambridge Technology, Inc., USA.

In the process of laser projection in accordance with some such example embodiments, the controller 15 moves the galvanometers 30 and 31 in coordinated manner. Light emitted by the laser 10 strikes, at first, minor 32 which steers the laser beam horizontally (H angle), and then it strikes mirror 33 which steers the laser beam vertically (V angle) and directs it toward the object surface 6. Here the laser light forms a tightly focused spot 40 (as shown in FIGS. 1, 2, and 4). As will be appreciated, the diameter of the beam spot will depend on factors such as the distance between the projector 1 and the object surface 6. In one example configuration, at a distance of about 5 meters between projector I and the object surface 6, the spot 40 has a diameter from about 0.3 to 1 mm. If laser beam 20 strikes surface 6 orthogonally then the shape of spot 40 is circular. Otherwise, its shape on the surface is elliptical.

With further reference to FIG. 2, the optical feedback pickup element 17 can be implemented, for example, with a beam splitter that has a transmission-to-reflection ratio from 50:50 to 90:10, in accordance with some embodiments. A ratio of 90:10 may be advantageous, for instance, because it is characterized by less beam power loss for the laser projection. During the ‘bucking-in’ operation described below, the aiming projector 1 scans fiducials 4 with its laser beam. When retro-reflective targets are used as fiducials, a portion of the laser light that strikes a fiducial returns back toward beam splitter 17 through beam steering system 14. Part of the returned light reflects from the beam splitter 17 toward photodetector 18. In some example embodiments, the power level of the light reaching the photodetector 18, in the case of using retro-reflective targets, is in the range of about 10 to about 100 nanowatts. Other embodiments may exhibit a different power level in this respect, as will be appreciated. The photodetector 18 can be implemented, for example, with a silicone photodiode with an amplifier that has sufficient gain to detect such power level, in accordance with some specific example embodiments.

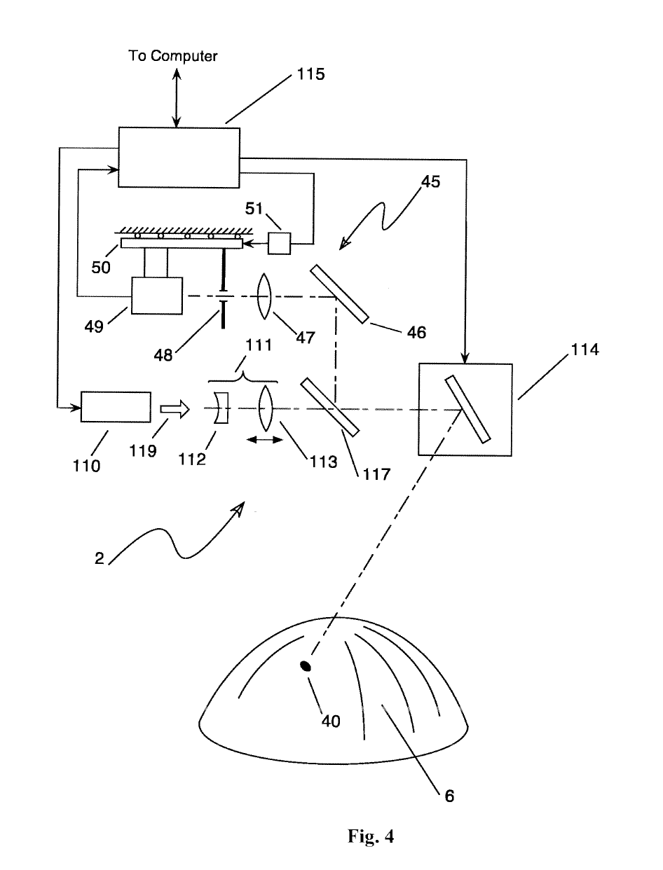

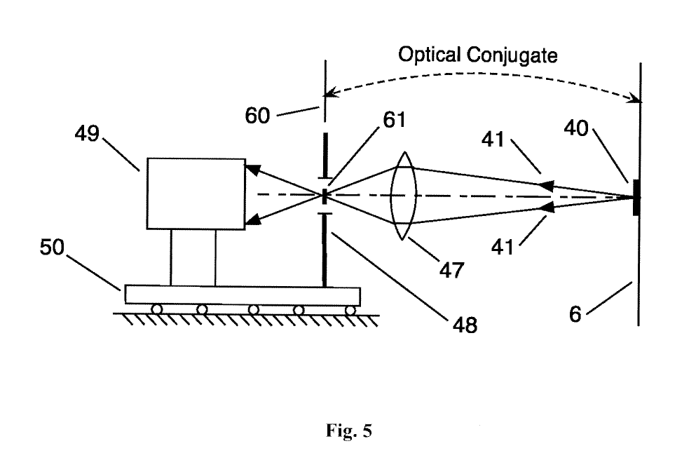

An embodiment the sensing laser projector 2 is shown in FIG. 4. As can be seen, some of its components involved in producing, shaping and directing the laser light can be the same as for the aiming projector, in some embodiments. For instance, in one specific such embodiment, laser 10 is the same as laser 10, focusable beam expander 111 with lenses 112 and 113 is the same as beam expander 11 with lenses 12 and 13, beam steering system 114 is the same as beam steering system 14, controller 115 is the same as controller 15, and beam splitter 117 is the same as beam splitter 17. Consequently, laser beam 119 is the same as laser beam 19 and the laser output beam produced by the sensing projector 2 during its “bucking-in” operation is the same as the output beam 20 produced by the aiming projector 1. However, note that the optical feedback subsystem 45 and its components are different from the optical feedback subsystem 16. Beside beam splitter 117, the optical feedback subsystem 45 of this example embodiment comprises a folding mirror 46, an imaging lens 47, an aperture mask 48, and a high sensitivity photodetector 49. In some cases, folding minor 46 has its reflective surface covered with a layer that reflects only light with the wavelength of lasers 10 and 110 (e.g., 532 nanometers in one example embodiment). It therefore works as a bandpass filter, reducing a background signal originated by ambient light and/or other sources. The aperture mask 48 and the photodetector 49 can be mounted together on slide 50 and they can be translated along the optical axis of lens 47 by the actuator 51 following commands from the controller I 15, in this example embodiment. During measurement operation, the optical feedback subsystem 45 of the sensing projector 2 provides sufficient detection capabilities for the part of laser light 20 that is diffusely reflected from the object surface 6. Because of diffusion, reflected laser light 41 (see, for example, FIGS. 1 and 5) is widely spread back toward the sensing projector 2. A relatively small portion of this diffusely reflected light 41 makes its way through the beam steering system 114 toward the beam splitter 117, which reflects at least part of reflect light 41 toward other components of the optical feedback subsystem 45. In some example embodiments, the power level of the light reaching the high sensitivity photodetector 49 during a measurement operation is in the range of about 50 to about 500 picowatts, although this range can vary from one configuration to the next as will be appreciated in light of this disclosure. The photodetector 49 can be implemented, for example, with a photo multiplier tube (PMT). Photo multiplier tubes are commercially available devices made, for example, by Hamamatsu Ltd., Japan. Other suitable photodetector technologies can be used as well, as will be appreciated.

FIG. 5 shows an optical diagram illustrating between components feedback subsystem 45 and the object surface 6 with laser spot 40, in accordance with one example embodiment. Note that components 114, 117, and 46 have been omitted from FIG. 5 to provide a focused discussion. In accordance with one such embodiment of this present invention, prior to scanning laser spot 40 by sensing projector 2, the aperture mask 48 (e.g., attached to slide 50 together with photodetector 49) is placed by actuator 51 into a plane 60 that is optically conjugate with the part of the surface 6 surrounding spot 40. In other words, it can be said that the aperture mask 48 is being “focused”. In this example case, “optically conjugate” is intended to mean that the lens 47 creates a real image 61 of the spot 40 focused onto the plane 60. The image is being formed by the optical beam of the diffusely reflected laser light 41. Aperture mask 48 effectively serves as an image analyzer during scanning operation by projector 2. Focusing the aperture mask 48 substantially improves measurement precision by reducing the impact of laser light speckles on finding a center of the spot 40, in accordance with such embodiments.

Alternatively, as will be appreciated in light of this disclosure, the aperture mask 48 and photodetector 49 could be mounted fixed but the lens 47 could be translated along its optical axis thus bringing the conjugate plane 60 with image 61 into the fixed plane of the aperture mask 48.

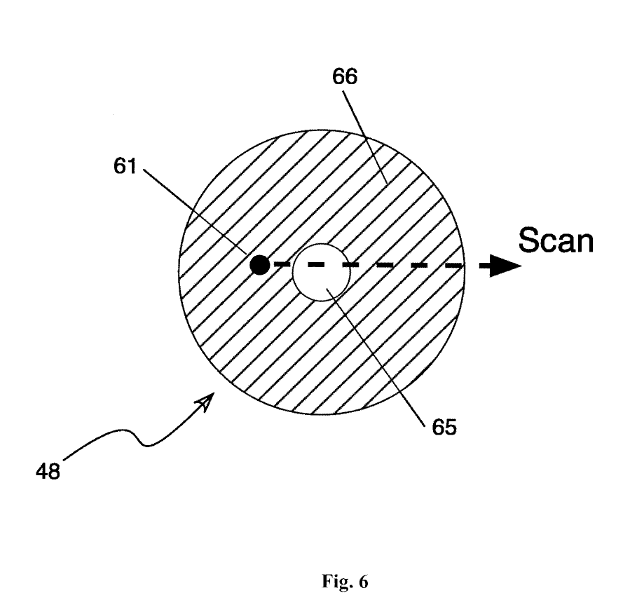

When spot 40 is being placed on surface 6 by aiming projector I, the rays of light 41 that are collected through beam steering system 114 and reflected from beam splitter 117 and folding mirror 46 are concentrated by the imaging lens 47 into image 61. When the aperture mask is focused, the image 61 is formed as a tight spot in the plane of the aperture mask 48. The real size of this concentrated image 61 is diffraction limited; in some example cases, for instance, it is a spot about 15 to 25 micrometers in diameter, for a spot 40 having an example diameter, as previously noted, of about 0.3 to 1 mm, An example aperture mask 48 is shown in detail in FIG. 6, according to one embodiment. In this example case, it is formed by a pinhole 65 in an opaque plate 66 oriented transversely to the optical axes of the lens 47. As the sensing projector 2 runs its beam steering system 114 to scan the area 42 around spot 40, its image 61 moves across the plate 66. When the image spot 61 crosses pinhole 65, the laser light goes through pinhole 65 into photodetector 49. Photodetector 49 converts the light into electrical signal and sends it to controller 115.

Numerous other embodiments of a lasergrammetry system with laser projectors will be apparent in light of this disclosure. In another embodiment, for instance, a lasergrammetry system has the same major components as in the example one illustrated by FIG. 1: an aiming laser projector I, a sensing projector 2, a computer 3, and a plurality of fiducials 4 associated with an object 5. However, the sensing laser projector 2 is enhanced to enable the object feature detection in accordance with the solution described in detail in the previously incorporated U.S. Pat. No. 7,306,339. For the enhancement, in one such example embodiment, the aperture mask 48 serves not only as an image analyzer during measurement operation but also as spatial filter suppressing internal scattering and excessive background light during feature detection operation, in accordance with the teaching of U.S. Pat. No. 7,306,339. Utilizing the sensing projector with object feature detection capabilities allows for performance of various advanced types of 3D measurement and in-process verification, for example, to combine edge detection with surface or plane fitting through the designated measurement points.

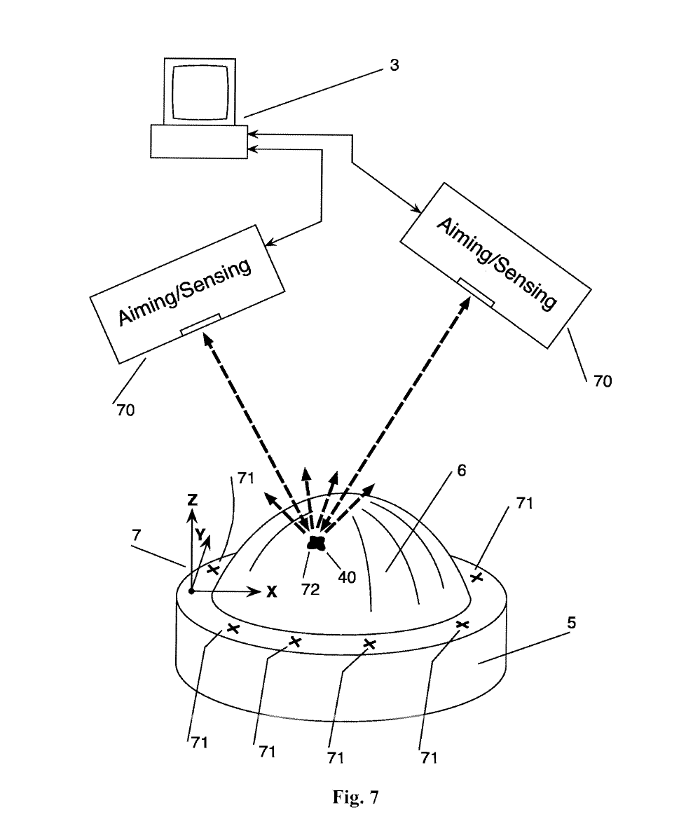

As will further be appreciated in light of this disclosure, note that sensing projector 2 can serve as an aiming projector. One such approach is implemented in the example embodiment illustrated by FIG. 7. This example lasergrammetry system has a symmetrical architecture and includes two aiming/sensing projectors 70, a computer 3, and a plurality of fiducials 71 associated with an object 5. Again, one function of the lasergrammetry system is to measure 3D coordinates of chosen points on a surface 6 of the object 5. In this embodiment, the fiducials 71 could be not only retro-reflective targets but any kind of contrast geometry features like holes, fasteners, edges and corners, etc. The laser projectors 70 can be both built as sensing projector 2, such that they are enhanced to enable the object feature detection as previously described. At the same time, both projectors are capable of serving as aiming projectors. Thus, for instance, the left projector can project spot 40 and the right projector can project spot 72 on the surface 6. Accordingly, in measurement operations, the right projector, as sensing, will scan the spot 40 and the left projector, as sensing, will scan the spot 72. As will be appreciated in light of this disclosure, such symmetrical system can achieve better accuracy by averaging the measurements performed, first, when one projector is aiming and the other is sensing and then, second, interchanging them.

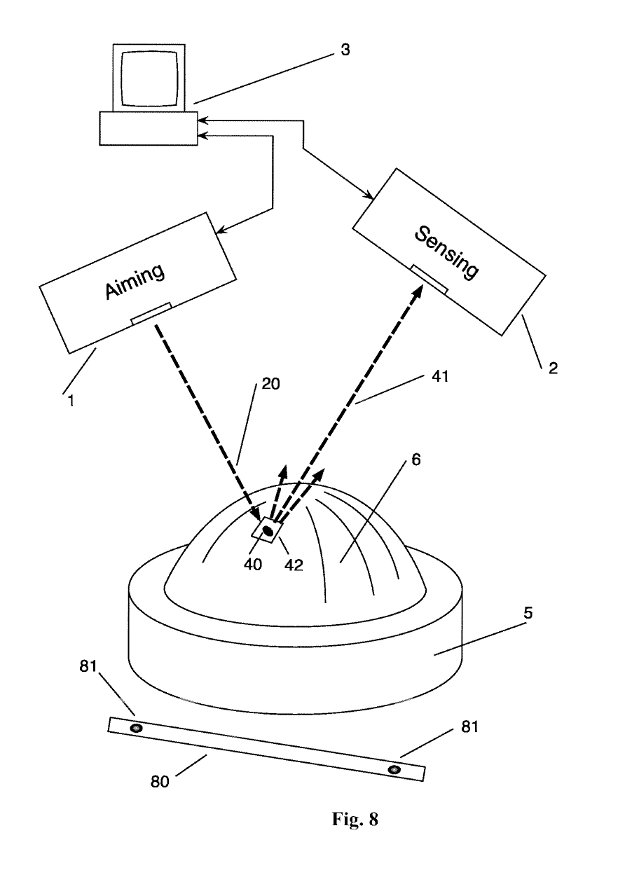

Another lasergrammetry system embodiment is illustrated by FIG. 8. As can be seen, this example lasergrammetry system does not include a fixed set of fiducials with known coordinates. Instead, it includes a free located scale rod 80 with at least two fiducials 81. The 81 is presumed to or otherwise detectable. In this exemplary embodiment, fiducials 81 can be implemented, for instance, with retro-reflective targets. The other components of the system depicted in FIG. 8 can be the same as for the first embodiment shown in FIG. 1: aiming laser projector 1, sensing laser projector 2, and computer 3. Again, in measurement operation, the aiming projector 1 produces the spot 40 on the surface 6 of the object 5, and the sensing projector 2 scans it. In accordance with this example embodiment, such a system can be used for general reverse engineering applications and, as it described further herein, the system provides 3D coordinate measurements of a group of points utilizing a bundle solution method similar to conventional photogrammetry methods.

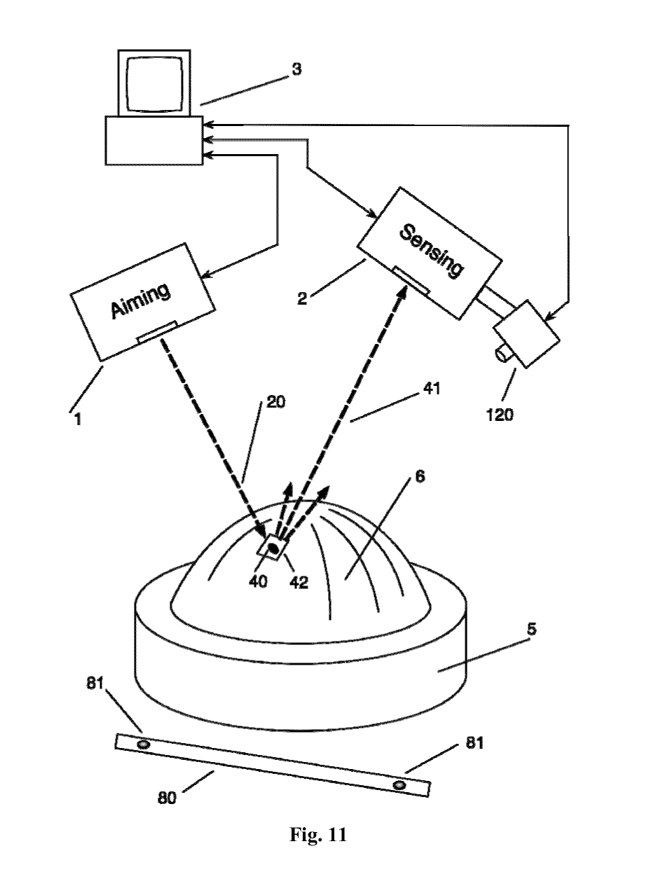

In various embodiments, adding an auxiliary video camera associated with the sensing projector can further enhance lasergrammetry systems of the type described herein. This solution allows speeding up the process of measuring an unknown object surface. It is especially effective for a system configuration intended for reverse engineering applications. An example of such enhanced embodiment is shown in FIG. 11. The video camera 120 is associated with the sensing projector 2 and it is connected to the computer 3.

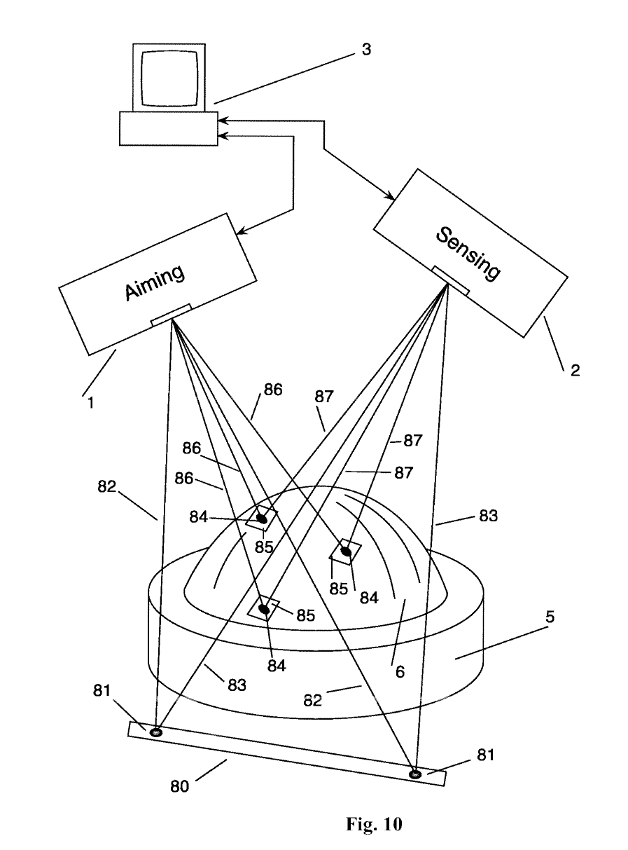

The video camera 120 is a typical industrial CCD or CMOS video camera with a lens having its angular field of view that is more or equal to the angular beam steering range of the galvanometer beam steering system 14 shown in FIG. 3. The resolution of the camera has to be sufficient to detect any spot produced by the aiming projector 1 on the surface 6 of the object 5. Typically, the conventional camera resolution of 640×480 pixels is adequate for the task. This camera has to be initially aligned and calibrated in such way that its location and orientation becomes known with respect to the coordinate system of the sensing projector 2. Camera 120 plays an auxiliary role in the process of measuring an unknown surface 6 by helping to speed up the capture of spots projected the aiming projector 1. As each spot is being projected, the camera 120 takes a snapshot of its whole field view. Computer 3 processes the image and determines the location of the spot in the camera pixel coordinates. Then, based on known location and orientation of the camera with respect to the projector, computer 3 calculates approximate values for the beam steering angles H and V associated with the captured spot image. It allows substantially reduce the size of the predetermined scan area 42 shown in FIG. 8 or FIG. 11 (or scan areas 85 shown in FIG. 10) thus reducing the scan times and speeding up the process of surface measurement.

It should be understood that the embodiment shown in FIG. 11 is only one example of integrating an auxiliary video camera with a lasergrammetry system. It is apparent to anyone skilled in the art that this solution is also applicable, for example, to enhance the dual aiming-sensing configuration illustrated in FIG. 7, so the two cameras could be used, each associated with the corresponding projector. (Such configuration is not shown in the drawings).

Numerous lasergrammetry methods for 3D coordinate measurements and in-process verification involving laser projectors will also be apparent in light of this disclosure. For instance, one example embodiment of a lasergrammetry method is method (M1) described below for 3D digitizing of the surface of an object. Referring to FIG. 1, this method relies on using at least two laser projectors the aiming projector I and the sensing projector 2. Furthermore, this method is based on utilizing a fixed set of fiducials 4. The method MI includes the following major steps (again, the use of the term steps is not intended to implicate a precise order, and other embodiments may have similar functionality performed in a different sequence):

M1-Step A. The aiming projector 1 utilizes its laser beam, optical feedback capabilities, and the set of fiducials 4 to determine the location and orientation of the projector in 3D space with respect to the object's coordinate system 7. The determination is based on a given set of coordinate data for fiducials 4 with respect to the coordinate system 7. This process referred herein by the phrase buck into the object's coordinate system. In some embodiments, a buck-in solution generally uses sequential scanning of cooperative or retro-reflective targets or features by the laser projector's beam as fiducials, processing optical feedback signals, finding the angular directional coordinates toward centers of those fiducials, and then computing the location and orientation of the projector. In some embodiments, at least six fiducial points are used, but other embodiments may user fewer fiducials (e.g., three) and other embodiments may user more fiducials (e.g., ten).

M1-Step B. The sensing projector 2 bucks into the coordinate system 7 in the same sequence as described in the MI-Step A for the aiming projector 1.

M1-Step C. The system performs sequential point-by-point measurement of the surface 6 and obtains a series of digitized 3D coordinates of the surface. As will be appreciated, this process depends on a particular application. One example of an application is verification of the surface 6 by comparing it with a given CAD model. In this case, the point-by-point measurement process can be automatic. The CAD model data can be stored, for example, in the computer 3. The computer 3 sequentially assigns the points on the surface 6 to be measured. As the location and orientation of both projectors 1 and 2 are known to computer 3, it calculates the beam steering angles for projector 1 to sequentially aim its laser beam toward measurement points and the beam steering angles for projector 2 to locate the centers of its predetermined scan areas at those points. In one example case, the time for a one point measurement provided by the exemplary embodiment of the lasergrammetry system described above is about 0.5 seconds. Another example application is a measurement of an unknown surface. In this case, the point-by-point measurement process can be semi-automatic or manual. In an example semi-automatic process, computer 3 can assign a regularly spaced array of the beam steering angles for projector 1 to sequentially aim its laser beam toward measurement points and an array of the beam steering angles for projector 2 to locate the centers of its predetermined scan areas at those points. Because the surface under measurement is unknown, this operation may include an additional step of searching the spot over a larger area by projector 2 prior to defining its beam steering angles corresponding to a center of a final scan area for each point of measurement. In an example manual process, for each measurement point, a user moves the aiming beam to a desired point on the surface 6 by controlling the projector 1 and by viewing location of the projected spot 40. The sensing projector 2 creates a glowing template referred to herein as a “scan box”. The scan box a predetermined square area 42 on the surface 6 where the scan of spot 40 will occur.

M1-Step D. In case of in-process verification, when the CAD model of the surface is known, compare measurement results with the model and present the difference in a convenient form for the user.

The actual point measurement operation carried out at step C includes the following steps, in accordance with one example embodiment:

M1-Step C1. The aiming projector 1 creates a stationary spot 40 on the surface 6. Computer 3 calculates the aiming ray of the beam 20 based on the given beam steering angle commands being sent to the system 14 through controller 15. Because the location and orientation of projector 1 with respect to coordinate system are known, the 6 components of the aiming ray (the start point coordinates and the directional cosines) can be computed in the coordinate system 7. In some such embodiments, the laser 10 stays continuously turned on.

M1-Step C2. The sensing projector 2 obtains its beam steering commands for the system 114 from computer 3 through controller 115. They provide allocation of the predetermined scan area 42 with its center positioned over the spot 40. In case of manual measurement pointing, a scan box can be projected.

M1-Step C3. Because the location and orientation of projector 2 with respect to coordinate system 7 are known, computer 3 can calculate an approximate distance from projector 2 to the surface 6. It then provides appropriate information to controller 115 which sends command to actuator 51 thus focusing aperture mask 48. Note that laser 110 can be turned off.

M1-Step C4. The sensing projector 2 scans the area 42 by executing a series of beam steering commands from controller 115 to the system 114. In one example embodiment, the scanning method is raster scanning, but in various embodiments any other suitable scanning technique may be used. During scan, the image 61 of the spot 40 moves across the aperture masks plate 66. Photodetector 49 converts the captured light into electrical signal and sends it to controller 115. Controller 115 samples the optical feedback signal at given incremental positions of the beam steering system 114. In other words, projector 2 operates as digitizing scanner. As the result of this scanning, controller 115 captures a digital “pixelized” image of the spot 40 with horizontal pixels representing sampling in the horizontal beam steering angle H, and vertical pixels representing sampling in the vertical beam steering angle V. As will be appreciated, note that the metric of the digital image captured by the projector 2 in this example embodiment is in angular units (radians or degrees).

M1-Step C5. Controller 115 sends the obtained digital image of the scanned spot 40 to the computer 3. The last one calculates the center of the spot image by running an image processing algorithm. This algorithm detects an edge of a circular or elliptical image and defines its center. Such algorithms can be implemented with conventional or custom technology. As will be appreciated, note that computer 3 can calculate the spot digital image center in terms of the H and V beam steering angles associated with it. Then computer 3 calculates the sensing ray—a chief ray or portion of the beam 41 directed toward the center of the spot 40. In some specific embodiments, this sensing ray, as the aiming ray computed in the M1-Step C1, has 6 components: the start point coordinates and the directional cosines. Because the location and orientation of projector 2 with respect to coordinate system 7 are known, the 6 components of the sensing ray can be computed in the coordinate system 7.

M1-Step C6. Computer 3 calculates the X, Y, Z coordinates of the 3D intersection between the aiming and sensing rays associated with the given measurement point. Note that, in general, the aiming and the sensing rays geometrically do not touch each other in 3D space. The math formulas and algorithm of finding an intersection solution as the closest point to both lines are well known. The intersection solution is assigned then as the measurement result for the given point location.

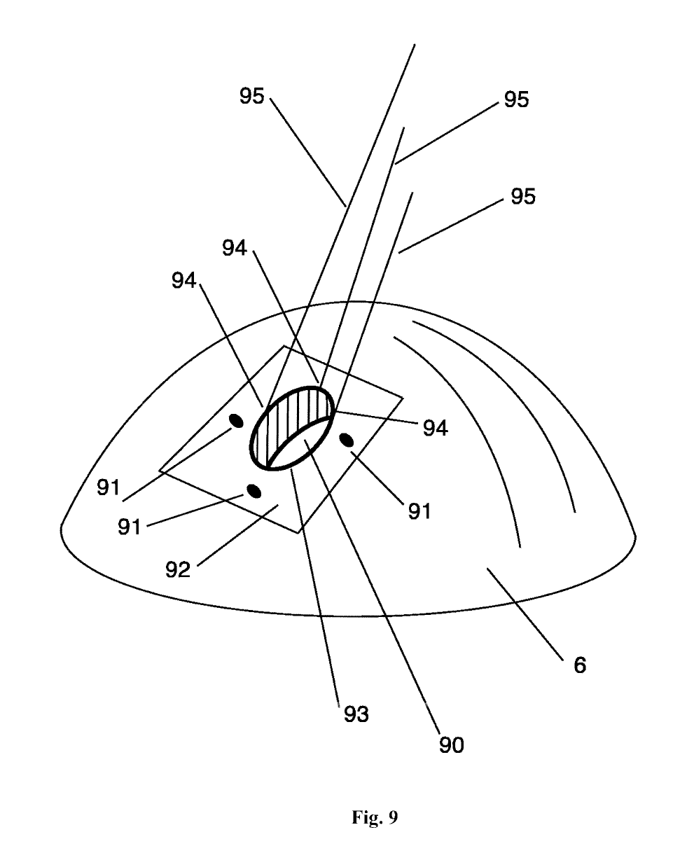

Another embodiment of a lasergrammetry method (M2) for 3D coordinate measurements and in-process verification is based on a lasergrammetry system utilizing an enhanced sensing laser projector capable of the object feature detection, such as the example system shown in FIG. 7. This method M2, as with the method M1 previously described, relies on using a fixed set of fiducials 4. Again, the 3D coordinates of the fiducials are presumed to be known with respect to the coordinate system 7. The method M2 solves advanced tasks of 3D object measurements, for example, measurement of a given feature edge in 3D space, as illustrated in FIG. 9. It shows a drilled hole 90 through the surface 6. In this example embodiment, the process of 3D edge location measurement for the hole 90 includes the following steps:

M2-Step A. The aiming projector bucks into the object coordinate system 7 in the same sequence as described above in the M1-Step A.

M2-Step B. The sensing projector bucks into the coordinate system 7 in the same sequence as described in the 21-Step A for the aiming projector.

M2-Step C. Following the step MI-Step C, the lasergrammetry system of this embodiment measures 3D coordinates of at least 3 points 91 on surface 6 in the vicinity of the hole 90.

M2-Step D. Computer 3 runs a surface fitting algorithm through the measured points 91 defining a small area surface, such as a plane 92, that surrounds the hole 90. When the points 91 are sufficiently close to the hole 90 the plane 92 accurately coincides with the part of surface 6 in the vicinity of hole 90.

M2-Step E. The sensing projector performs a feature detection scan over the area of hole 90. It detects the top edge 93 of the hole 90. A detailed description of the feature edge detection process by a laser projector with feature detection capabilities, in accordance with one example embodiment, is given in the previously incorporated U.S. Pat. No. 7,306,339. For the plurality of edge points 94, the sensing projector determines the plurality of beam steering angles H and V associated with them.

M2-Step F. Based on the plurality of beam steering angles, computer 3 calculates a plurality of sensing rays 95 as chief rays of the sensing projector directed toward the plurality of edge points 94. In some such specific embodiments, every computed sensing ray has 6 components: the start point coordinates and the directional cosines. Because the location and orientation of the sensing projector with respect to coordinate system 7 are known, the 6 components of the sensing ray can be computed in the coordinate system 7.

M2-Step G. Computer 3 calculates the X, Y, Z coordinates of 3D intersections between all the sensing rays 95 associated with the plurality the edge points 94 and the plane 92. Any suitable known math formulas of finding an intersection between a line and a plane can be used. The plurality of intersection coordinates X, Y, Z is assigned as the measurement result for the edge location.

Another embodiment of a lasergrammetry method (M3) for 3D coordinate measurements is intended for general reverse engineering applications involving 3D surface digitizing and it can be carried out, for instance, by the embodiment of the lasergrammetry system shown in FIG. 8. This method M3 does not require usage of a fixed fiducial set with known coordinates. Instead, it utilizes a free located scale rod 80 with at least two fiducials 81. The distance between fiducials is presumed to be known, or otherwise detectable. The embodiment this method M3 is illustrated in FIG. 10. The surface 6 that is needed to be digitized presumed to be unknown. Locations and orientations of projectors 1 and 2 with respect to the object 5 are also unknown. The method M3 includes the following steps:

M3-Step A. The aiming projector 1 sequentially scans fiducials 81 utilizing its laser beam and its optical feedback. The projector's I controller 15 determines the beam steering angles H and V associated with each fiducial and defining the rays 82.

M3-Step B. The sensing projector 2 sequentially scans fiducials 81 utilizing its laser beam and its optical feedback. The projector's 2 controller 115 determines the beam steering angles H and V associated with each fiducial and defining the rays 83.

M3-Step C. The aiming projector 1 sequentially projects stationary spots 84 on the surface 5 following a set of beam steering angles H and V assigned by user. The rays 86 associated with those beam steering angles are shown in the FIG. 10.

M3-Step D. At each location of spot 84, the sensing projector 2 sets up a predetermined scan area 85 where the scan of spot 84 will occur.

M3-Step E. Following action of projector 1 placing light spots 84, one after another, the sensing projector 2 sequentially scans areas 85, one after another. In a similar fashion as described with reference to step M3-Step C4, the sensing projector's controller determines the beam steering angles II and V for the centers of spots 84. The rays 87 associated with those beam steering angles are shown in the FIG. 10.

M3-Step F. After all scans are completed, computer 3 runs a bundle solving calculation that simultaneously involves the whole set of beam steering angles for all the measurement points and the scale bar fiducials and results a set of X, Y, Z coordinates of all the measurement points. In some embodiments, the minimum number of measurement points in this method is 6, although other embodiments may have fewer (e.g., 2 or 3) or more (e.g., 10 or more). The bundle solving algorithm can be implemented, for instance, using conventional techniques applicable to photogrammetry.

Devices, systems, and methods of the types described herein may exhibit a number of advantages over other techniques. For example, in various embodiments, devices, systems, and methods of the types described herein may allow a surface to be digitized without requiring physical contact between the surface being digitized and the retro-reflective target being placed on the surface. Accordingly, systems of the type described herein may avoid contact measurements and so may be, e.g., suitable as in-process verification operations for many important manufacturing applications, for example producing composite parts in aerospace industry. This is in contrast to digitization techniques of the types described in U.S. Pat. No. 5,661,667.

In some embodiments, devices, systems, and methods of the types described herein may allow a surface to be digitized without the need for a laser projector and a video camera with a lens and a separate galvanometer scanner (e.g., as described in U.S. Pat. No. 5,615,013). Accordingly, accuracy losses may be avoided that would result from a combination of the camera lens distortion and galvanometer non-linearity. In some applications, such distortions may make it practically impossible to achieve a level of accuracy required, e.g., for modern aerospace industrial applications. A further advantage is that by avoiding the need for two different optical paths for laser projection and camera imaging one eliminates the necessity for frequent mutual calibration between the camera imaging system and the laser projection system.

In some embodiments, devices, systems, and methods of the types described herein may allow a surface to be digitized without the need for a laser projector and one or two CCD cameras that can be swiveled in two directions and provided with an optical zoom function (e.g., of the type disclosed in US Patent Application Publication No. 2007/0058175 A1), thereby avoiding the low speed (e.g., due to the requirement for mechanical actuation of the swiveling cameras) and accuracy associated with such systems.

In some embodiments, devices, systems, and methods of the types described herein may allow for accurate lasergrammetry in 3D space. This is in contrast to systems of the type described in U.S. Pat. No. 7,306,339. As it stated there, the proposed laser projector with object feature detection is capable of detecting a spot projected onto an object surface by another laser source. However, as disclosed, it cannot be used for accurate lasergrammetry in 3D space because it detects the projected laser light with a photodetector with the pinhole works as a light collector only. This will introduce substantial errors in determining the laser spot location when the object surface is not in a conjugate image plane with the pinhole.

In some embodiments, devices, systems, and methods of the types described herein may allow for feature detection and surface digitizing without the need for an expensive and complicated laser radar system, e.g., of the type disclosed in U.S. Pat. No. 8,085,388.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A lasergrammetry system, comprising:
an aiming laser projector configured to direct a focused laser beam toward a designated point on a surface of an object thus producing a stationary laser light spot on the surface; and
a sensing laser projector configured to scan, detect, and locate the laser light spot created by the aiming laser projector;
wherein the aiming and sensing laser projectors are associated with aiming and sensing optical paths, respectively.

2. The system of claim 1, further comprising:
a computer configured to calculate 3D coordinates of the designated point using ray direction vectors associated with the aiming and sensing optical paths.

3. The system of claim 1 or 2 wherein a fixed set of fiducials are provided on the object, and both the aiming and the sensing laser projectors are further configured to obtain optical feedback signals from the fiducials and to define the location and orientation of the aiming and sensing projectors in 3D space with respect to a coordinate system of the object.

4. The system of any of the preceding claims wherein the aiming laser projector includes a laser, a focusable beam expander, a beam steering system, a controller, and an optical feedback subsystem capable of detecting a portion of laser light reflected from a fiducial on the object.

5. The system of claim 4 wherein the optical feedback subsystem includes a photodetector configured to receive said portion of the reflected laser light and convert it into an electrical image signal that corresponds to the intensity of the detected feedback light.

6. The system of any of the preceding claims wherein the sensing laser projector includes a laser, a focusable beam expander, a beam steering system, a controller, and an optical feedback subsystem capable of detecting a portion of laser light reflected from a fiducial on the object.

7. The system of claim 6 wherein the optical feedback subsystem includes a high sensitivity photodetector that is configured to detect said portion of the reflected laser light, and to detect a portion of the aiming projector's light reflected from the object surface.

8. The system of claim 7 wherein the optical feedback subsystem further includes an imaging lens having an optical axis and an aperture mask in front of the high sensitivity photodetector.

9. The system of claim 8 wherein the aperture mask is translatable together with the photodetector along the optical axis of the imaging lens.

10. The system of any of the preceding claims wherein the sensing laser projector is configured to allow object feature detection.

11. The system of claim 10 wherein a set of fiducials are provided on the object, and the fiducials are inherent to the object.

12. The system of any of the preceding claims wherein each of the aiming and sensing laser projectors is capable of functioning as the aiming laser projector or as the sensing laser projector.

13. The system of any of the preceding claims wherein the system is configured for reverse engineering applications and to provide 3D coordinate measurements a group of points utilizing a bundle solution.

14. The system of claim 13 further comprising a free located scale rod with at least two fiducials.

15. The system of any preceding claim further comprising at least one auxiliary video camera configured to image at least a portion of the object, wherein the system is configured to use a signal from the video camera to at least partially control the operation of the sensing projector.

16. The system of claim 15, wherein:
the video camera is configured to obtain one or more images of the laser light spot on the surface, and
the system is configured to control the sensing projector to sense a limited area of the surface corresponding to the laser light spot based at least in part on the one or more images.

17. A lasergrammetry method comprising:
using an aiming laser projector to direct a focused laser beam toward a designated point on a surface of an object thus producing a stationary laser light spot on the surface; and
using a sensing laser projector to scan, detect, and locate the laser light spot created by the aiming laser projector;
wherein the aiming and sensing laser projectors are associated with aiming and sensing optical paths, respectively.

18. The method of claim 17, further comprising:
calculating 3D coordinates of the designated point using ray direction vectors associated with the aiming and sensing optical paths.

19. The method of claim 17, wherein the calculating step is carried out using at least one computer.

20. The method of any preceding claim, comprising:
providing a fixed set of fiducials on the object, and
using the aiming and the sensing laser projectors to obtain optical feedback signals from the fiducials and to define the location and orientation of the aiming and sensing projectors in 3D space with respect to a coordinate system of the object.

21. The method of any preceding claim, wherein the aiming laser projector includes a laser, a focusable beam expander, a beam steering system, a controller, and an optical feedback subsystem, and further comprising:
using the optical feedback system to detect a portion of laser light reflected from a fiducial on the object.

22. The method of claim 21, wherein the optical feedback subsystem includes a photodetector, and further comprising:
using the photodetector to receive said portion of the reflected laser light and convert it into an electrical image signal that corresponds to the intensity of the detected feedback light.

23. The method of any preceding claim, wherein the sensing laser projector includes a laser, a focusable beam expander, a beam steering system, a controller, and an optical feedback subsystem, and further comprising:
using the optical feedback subsystem to detect a portion of laser light reflected from a fiducial on the object.

24. The method of claim 23, wherein the optical feedback subsystem includes a high sensitivity photodetector, and further comprising:
using the photodetector to detect said portion of the reflected laser light, and to detect a portion of the aiming projector's light reflected from the object surface.

25. The method of claim 24, wherein the optical feedback subsystem further includes an imaging lens having an optical axis and an aperture mask in front of the high sensitivity photodetector, and further comprising:
translating the aperture mask together with the photodetector along the optical axis of the imaging lens.

26. The method of claim preceding claim, comprising detecting one or more features using the sensing laser projector.

27. The method of any preceding claims wherein the object includes one or more inherent fiducials.

28. The method of any preceding claim, wherein each of the aiming and sensing laser projectors is capable of functioning as the aiming laser projector or as the sensing laser projector.

29. The method of any of the preceding claims comprising:
implementing one or more reverse engineering applications; and
providing 3D coordinate measurements a group of points utilizing a bundle solution.

30. The method any preceding claim further comprising:
obtaining a video image of at least a portion of the object, and
using a signal from the video camera to at least partially control the operation of the sensing projector.

31. The method of claim 30, comprising:
obtaining one or more images of the laser light spot on the surface, and
controlling the sensing projector to sense a limited area of the surface corresponding to the laser light spot based at least in part on the one or more images.

32. The method of any one of claims 17-31, wherein the object comprises a set of fiducials, the method comprising:
using the aiming projector and the fiducials to determine the location and orientation of the projector in 3D space with respect to the object's coordinate system based at least in part on coordinate data for the fiducials with respect to the coordinate system;
using the sensing projector and the fiducials to determine the location and orientation of the projector in 3D space with respect to the object's coordinate system based at least in part on coordinate data for the fiducials with respect to the coordinate system;
performing a sequential point-by-point measurement of a surface of the object to obtains a series of digitized 3D coordinates of the surface.

33. The method of claim 32, further comprising comparing the wherein series of digitized 3D coordinates of the surface to a model of the surface.

34. The method of claim 33, further comprising generating an output indicative of differences between the digitized 3D coordinates and the model.

35. The method of any one of claims 17-31, wherein the object comprises a set of fiducials, the method comprising:
using the aiming projector and the fiducials to determine the location and orientation of the projector in 3D space with respect to the object's coordinate system based at least in part on coordinate data for the fiducials with respect to the coordinate system;
using the sensing projector and the fiducials to determine the location and orientation of the projector in 3D space with respect to the object's coordinate system based at least in part on coordinate data for the fiducials with respect to the coordinate system;
using the aiming and sensing projectors, to measure 3D coordinates of at least three points in the vicinity of a feature on the object having an edge;
generating a model of the surface of the object in the vicinity of the feature based on the 3D coordinates;
using the sensing projector to detect the edge of the feature; and
determining 3D coordinates for one or more points associated with the edge.

36. The method of claim 35, wherein comprises:
determining beam steering angles associated with a plurality of points corresponding to the detected edge;
determining a plurality of sensing rays based on the beam steering angles; and
determining points where the sensing rays would intersect the surface based on the model of the surface.

37. The method of claim 36, wherein the model comprises a planar fit to the surface.

38. The method of any one of claims 35-37, wherein the feature comprises a hole.

39. The method of any one of claims 35-38, further comprising performing process verification based on measurements of the object.

40. The method any one of claims 17-31, comprising: providing a free located scale rod with at least two fiducials in the vicinity of the object.

41. The method of claim 40, comprising:
scanning fiducials of the scale rod with the aiming projector and, the sensing projector;
determining beam steering angles associated with the fiducials for both the aiming projector and the sensing projector;
assigning object surface points for measurement,
using the aiming laser projector, projecting stationary laser spots onto the surface of the object at desired points; and
using the sensing laser projector to scan the spots to determining the beam steering angles corresponding to the center of each spot for both the aiming projector and the sensing projector/

42. The method of claim 41, wherein the step of using the sensing laser projector to scan the spots is performed while sensing projector is not projecting a laser beam.

43. The method of claim 41 or claim 42 comprising performing a bundle solving calculation based on an entire set of beam steering angles for all the measurement points and the scale bar fiducials to generate 3D coordinates of all the measurement points.

44. A non-transitory computer readable media comprising a set of instructions that, when executed, case a lasergrammetry system to implement the method of any one of claims 17-43.
